(19) United States
(12) Patent Application Publication
(10) Pub. No.: US 2024/0181414 A1
(43) Pub. Date: Jun. 6, 2024

(54) FILTRATION DEVICE FOR A DOWN-FLOW HYDROPROCESSING REACTOR

(71) Applicant: CHEVRON U.S.A INC., San Ramon, CA (US)

(72) Inventors: Steven Xuqi SONG, El Cerrito, CA (US); Matthew D. POLAND, Oakland, CA (US); Matthew D. FORMEL, Long Beach, CA (US); David KASHEVAROFF, Vacaville, CA (US); James France, Vallejo, CA (US); Timothy D. EVANS, Moss Point, MS (US)

(21) Appl. No.: 18/556,671

(22) PCT Filed: Apr. 21, 2022
(86) PCT No.: PCT/US2022/025823

§ 371 Date: Oct. 21, 2023

Related U.S. Application Data
(60) Provisional application No. 63/177,950, filed on Apr. 21, 2021.

(51) Int. Cl. B01J 8/00; B01D 24/04; C10G 49/00

(52) U.S. Cl. CPC B01J 8/006; B01D 24/04; C10G 49/002

(57) ABSTRACT

A filtration device for a down-flow catalytic hydroprocessing reactor is disclosed. The filtration device may be used in the petroleum and chemical processing industries in catalytic reactions of hydrocarbonaceous feedstocks in the presence of hydrogen, at an elevated temperature and pressure, to remove contaminants from mixed gas and liquid feedstreams to reactor catalyst beds. The filtration device may be provided as a horizontal tray installation at the top of a reactor, whereby feedstream liquid is passed through a filtration media in a radially inward direction from the wall of the reactor to the center of the filtration device and thereafter to the reactor catalyst bed. Among the benefits provided are the minimization of scale and small/fine particulates that reach the catalyst bed below the device, reduced pressure drop through the reactor, even when the filter is completely fouled, and the potential for added catalyst volume due to the reduced need to use catalyst grading materials.

### CROSS-REFERENCE TO RELATED APPLICATIONS

This application claims the benefit of priority to U.S. Provisional Patent Appl. Ser. No. 63/177,950, filed on Apr. 21, 2021, entitled “FILTRATION DEVICE FOR A DOWN-FLOW HYDROPROCESSING REACTOR”, the disclosure of which is herein incorporated by reference in its entirety.

### FIELD OF THE INVENTION

A filtration device for a down-flow catalytic hydroprocessing reactor is disclosed. The filtration device may be used in the petroleum and chemical processing industries in catalytic reactions of hydrocarbonaceous feedstocks in the presence of hydrogen, at an elevated temperature and pressure, to remove contaminants from mixed gas and liquid feedstreams to reactor catalyst beds.

### BACKGROUND OF THE INVENTION

In fixed-bed hydroprocessing reactors, gas and liquid reactants (e.g. hydrogen and a hydrocarbonaceous feedstock) flow downward through one or more beds of solid catalyst. (See, e.g. U.S. Pat. No. 4,597,854 to Penick). As the reactants flow downward through the reactor catalyst beds, the reactants contact the catalyst materials and react to produce the desired products. Reactor feedstreams may also contain foulants and contaminants, leading to unwanted deposits, including the formation of organic deposits such as gums.

Foulants carried in the liquid feedstream can cause fouling on the top distributor tray in a reactor and in the catalyst beds, leading to unwanted pressure drop increases that limit the performance of the reactor. Undesirable problems can result, including shorter run lengths, unplanned downtime, unused catalyst activity, non-uniform liquid distribution in catalyst bed, hot spot formation in the catalyst beds, and increased maintenance, such as distributor tray cleaning. Solutions to mitigate such problems include installing feed filters, bed grading, and, in some cases, filter trays above the top distributor tray.

Grading products have been used in some cases in the first catalyst bed for feed contamination removal. While such solutions generally show performance benefits, valuable reactor volume is taken away from the active catalyst volume thereby reducing the operating runtime and/or online performance. The use of grading beds also does not prevent fouling on the top distributor tray.

Feed filters may also be installed before the reactor inlet, and, in some cases, may be operated at lower temperatures than are used for the feedstream entering the reactor. When filtered liquid feed is subsequently mixed with hydrogen and heated in a furnace before flowing into the reactor inlet, additional organic deposits such as gum can be formed during this heating process after the feed filter. A means to remove sludge and contaminants in the reactor inlet header is therefore desirable to protect the top distributor tray and catalyst bed. A continuing need therefore exists for improvements in down-flow reactors, including devices for removing feedstream contaminants.

### SUMMARY OF THE INVENTION

The present invention is directed to a filtration device for a down-flow hydroprocessing reactor. The device provides effective removal of contaminants from a liquid feedstream to a catalyst bed in a hydroprocessing reactor. The filtration device provides effective removal of fines and other contaminants, while minimizing the pressure drop through the device. The device is well-suited for retrofit applications and can be used for new reactor designs to achieve efficient feedstream contaminant removal so that reactor catalyst beds and reactor internals are not fouled and reactor operational performance is improved.

In addition to minimizing pressure drop through the filtration device during operation while contaminants are being removed, there is no additional pressure drop through the device once the filtration media has become completely fouled, i.e., filled with removed contaminants.

The filtration device generally includes a top plate having inner and outer surfaces and a top plate periphery; a base plate generally parallel to the top plate having inner and outer surfaces, a base plate periphery, and a base plate aperture; a base plate aperture containment barrier; a support structure for the top plate; a separator on top of filtration media; and filtration media contained within the device and on top of the base plate. The top and base plates are separated by a distance to define an interior volume of the filtration device, such that the interior volume comprises a filtration media volume located on top of and adjacent to the base plate inner surface and a flow bypass volume located on top of the filtration media volume and adjacent to the top plate inner surface. The base plate aperture containment barrier retains filtration media on the base plate, and is generally located around the perimeter of the base plate aperture and extends from the base plate to the top of the filtration media volume or the bottom surface of the top plate. The support structure for the top plate is generally positioned within the interior volume of the filtration device and comprises one or more supports to provide and maintain the separation distance between the top plate and the base plate. The separator is positioned between the filtration media volume and the flow bypass volume. The separator is generally a thin, porous material that is parallel to both the top plate and the bottom plate. The separator contains the filter media within the filtration media volume, and allows liquid to flow into the filtration media volume.

In general, the base plate, the top plate, and the separator are centrally positioned about the same central perpendicular axis. The separator generally has the same areal dimension as the bottom plate. The top plate generally has a smaller areal dimension than the bottom plate so that feedstream liquid and gas can flow into the filtration device inlet between the periphery of the top plate and the periphery of the base plate.

The invention also relates to a down-flow hydroprocessing reactor comprising the filtration device and to a process for removing contaminants from a liquid feedstream in such a reactor. The process generally comprises passing a feedstream to a down-flow catalytic hydroprocessing reactor through the filtration device installed at the top of the reactor, wherein the liquid and gas components of the feedstream are routed through the inlet to the filtration device between the periphery of the top plate and the periphery of the base plate. The feedstream liquid passes through the filtration media contained within the filtration media volume and the feedstream gas passes through the flow bypass volume of the filtration device interior volume.

### BRIEF DESCRIPTION OF THE DRAWINGS

FIGS. 1-6 provide representative views of a filtration device according to an embodiment of the invention. The scope of the invention is not limited by these representative figures and is to be understood to be defined by the appended claims.

FIG. 1 shows a side view of an embodiment of the filtration device of the invention.

FIG. 2 shows a side view of an embodiment of the filtration device of the invention installed in the top of a reactor, with the side cross-section of the reactor wall and an existing distribution tray (also referred to herein as a perforated tray) also shown.

FIG. 3 shows the same view as in FIG. 2 with the flow paths of feedstream liquid and gas also shown.

FIG. 4 shows a ¾ quarter cutout view of the filtration device positioned within a reactor section with the top plate and separator removed (also showing an existing tray below the filtration device).

FIG. 5 shows a ¾ quarter cutout view of the filtration device positioned within a reactor section as in FIG. 4 with the separator in place (also showing an existing tray below the filtration device).

FIG. 6 shows a ¾ quarter cutout view of the filtration device positioned within a reactor section as in FIG. 5 with the top plate in place (also showing an existing tray below the filtration device).

### DETAILED DESCRIPTION

Specific embodiments and benefits are apparent from the detailed description provided herein. It should be understood, however, that the detailed description, figures, and any specific examples, while indicating beneficial embodiments, including some that are preferred, are intended for purposes of illustration only and are not intended to limit the scope of the invention.

The invention is directed to a filtration device for a down-flow hydroprocessing reactor. The device comprises a top plate having inner and outer surfaces and a top plate periphery; a base plate generally parallel to the top plate having inner and outer surfaces, a base plate periphery, and a base plate aperture; a base plate aperture containment barrier; a support structure for the top plate; a separator on top of filtration media; and filtration media contained within the device and on top of the base plate.

The top and base plates are separated by a distance to define an interior volume of the filtration device, such that the interior volume comprises a filtration media volume located on top of and adjacent to the base plate inner surface and a flow bypass volume located on top of the filtration media volume and adjacent to the top plate inner surface. The base plate aperture containment barrier retains filtration media on the base plate, and is generally located around the perimeter of the base plate aperture and extends from the base plate to the top of the filtration media volume or the bottom surface of the top plate. The support structure for the top plate is generally positioned within the interior volume of the filtration device and comprises one or more supports to provide and maintain the separation distance between the top plate and the base plate. The separator is positioned between the filtration media volume and the flow bypass volume. The separator is generally a thin, porous material that is parallel to both the top plate and the bottom plate. The separator contains the filter media within the filtration media volume, and allows liquid to flow into the filtration media volume.

The containment barrier may generally be liquid permeable throughout the width and height of the barrier. In some embodiments, the containment barrier may be liquid permeable in a portion of the width and/or height of the barrier while liquid impermeable (or liquid permeable to a lesser degree) to allow liquid to be retained within the filtration volume. The device does not need or necessarily include an outer perimeter containment barrier located around the perimeter of the base plate extending from the base plate to the top of the filtration media volume or the bottom surface of the top plate. The filtration media need not be contained around the perimeter of the base plate through the use of an outer perimeter containment element.

In general, the base plate, the top plate, and the separator are centrally positioned about the same central perpendicular axis. The separator generally has the same areal dimension as the base plate. The top plate generally also has a smaller areal dimension than the bottom plate so that feedstream liquid and gas can flow into the filtration device inlet between the periphery of the top plate and the periphery of the base plate. While the filtration device is not necessarily limited to a particular shape or dimensions, in most cases the device will match the cross-sectional shape of a new or existing reactor; typically, the filtration device is circular in shape such that each of the top plate, the base plate, and the separator are circular and dimensioned to correspond to the internal dimensions of a reactor and to fit horizontally within the top space of the reactor. In cases where the device is generally circular, the distance between the outer perimeter of the top plate (also referred to herein as the top flow diverter plate) and the outer perimeter of the base plate is an annular area around the outside of the device through which feedstream liquid and gas that has been diverted to the outside of the reactor enters the device and flows inward toward the base plate aperture.

The top plate, the base plate, and the separator may also be formed as a plurality of sections that together form the respective top plate, the base plate, or the separator. The use of sections for certain device components like the top plate, base plate and the separator allows sections to be placed within or to be removed from the reactor through a reactor internal access location, such as a manway, thereby facilitating installation and maintenance.

Various support structures may be used to support the top plate, or sections of the top plate, and provide a distance between the top plate and the base plate. For example, a plurality of cross members, such as trusses, that span the sectional distance between the walls of the reactor may be used to support the top plate. The support structures, or more particularly the cross members, will typically be supported by structures within the reactor, such as by a supporting member that rests on top of an existing tray or through other connections to the reactor or reactor internals. In some cases, e.g., when cross members are used, the support structure may also be used to support the separator or sections of the separator. The support structures may also support the base plate or sections of the base plate. In one embodiment, the support structures comprise a plurality of cross member trusses that span the distance from one reactor wall to the other side of the reactor across a section of the reactor cross-section such that the base plate is supported on the lower portion of the truss, the separator is supported on an intermediate position of the truss, and the top plate is supported by the top of the truss. In the case where each of the top plate, base plate, and separator comprise sections of the respective component, each section may be configured and arranged to be supported within the spaces between the trusses.

The separator generally defines the area between the filtration media volume and the bypass flow volume within the filtration device. Typically, the separator is a thin, porous material that functions to hold the filtration media in place and within the filtration media volume. Various materials may be used, such as those that are wire based, as well as grid, mesh, screen, or perforated metals. While not particularly limited, the separator, or sections thereof, may be somewhat rigid to aid in installation and to help maintain their placement during operation. In some embodiments, the separator may be an optional component, and may not necessarily be included in the device, e.g., if the separator is not required for the filtration media to remain contained within the filtration media volume.

The base plate aperture allows for feedstream liquid and gas to pass through the filtration device and flow to other down locations in the reactor, e.g., to a distributor tray below the filtration device. The size of the aperture may vary and is not particularly limited (other than to avoid introducing a flow restriction and to allow for efficient use of the filtration volume). The base plate aperture may be shaped to provide manway access to reactor internals below the filtration device.

Various filtration media may be used to provide contaminant removal within the filtration volume. While suitable materials generally include any known in the art, typically an absorbent material that is convenient to load, maintain and remove will be used. Such materials are commercially available and are typically provided in pellet or other usual shapes for hydroprocessing reactors. In some cases, a pellet shaped absorbent filtration media having a nominal length in the range of about 5 mm to about 20 mm may be useful.

The invention further relates to the use of the filtration device according to the invention in a hydroprocessing system, especially in a down-flow hydroprocessing reactor, e.g., as a contaminant removal tray located internally at the top of such reactors and to hydroprocessing reactor systems that use the filtration device.

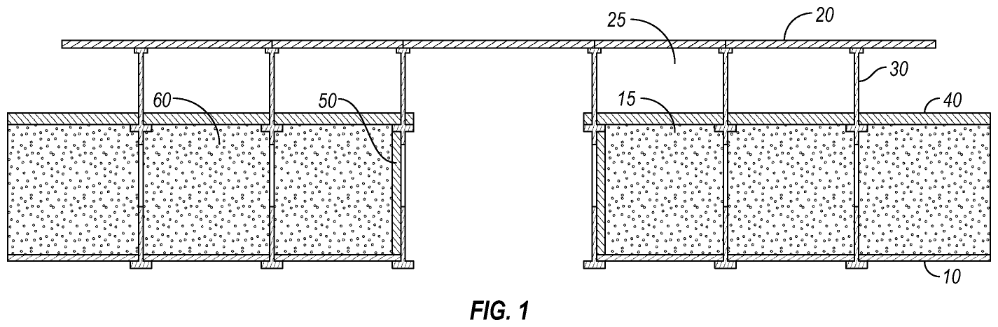

In one embodiment of the invention, as represented by FIGS. 1 to 6, a filtration device may have a central cross-sectional view as shown in FIG. 1. The base plate 10 forms the lower part of the filtration device with the top formed by the top plate 20 (also referred to as the deflector tray since it helps to deflect the liquid and gas flow to the outside of the reactor). The base plate 10 has an opening referred to as the base plate aperture that is generally centrally located on the base plate to allow liquid and gas to flow down through the device, e.g., to a distribution tray below the filtration device. Cross members, which may be trusses 30, are shown to support the base plate and the top plate. The separator 40 between the lower filtration volume 15 and the upper flow bypass volume 25 separates the interior volume of the device into two flow sections and is also supported by the cross members 30. The containment barrier 50 surrounds the base plate aperture in the center of the filtration device which allows liquid and gas to flow through the device and downward to existing reactor internals, such as a perforated distribution tray. Filtration media 60 is contained within the filtration media volume 15. The top plate 10 may also have an opening generally corresponding to the base plate aperture opening to allow access to the interior of the filtration device. Although not required, the base plate 10, the top plate 20, and the separator 40 may be each provided in the form of more than one section(s) that are located between the cross members 30. In some cases, one or more of the base plate 10, the top plate 20, and the separator 40 may be each provided as non-sectioned, whole components of the filtration device.

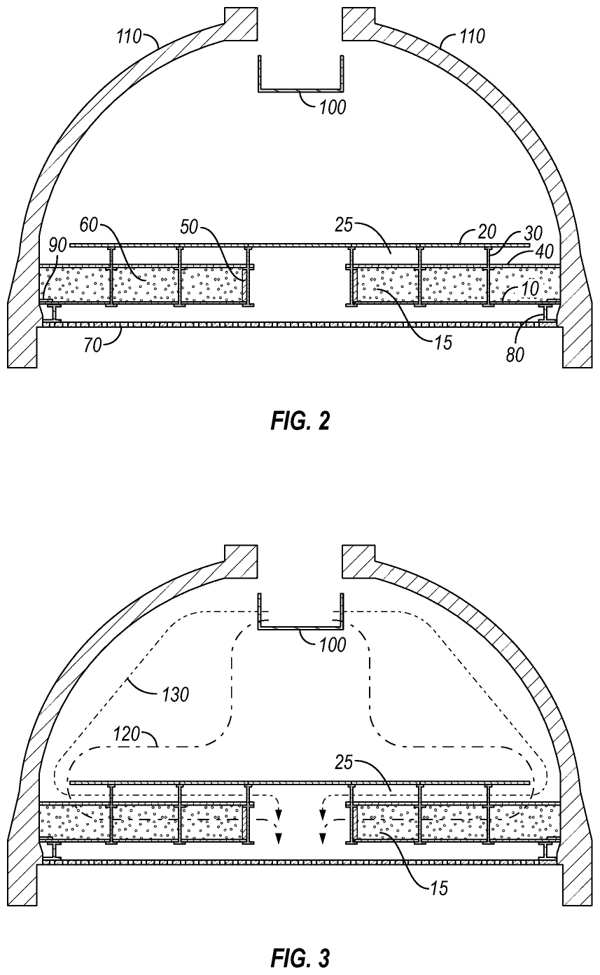

FIG. 2 shows the same central cross-sectional view as FIG. 1 in an embodiment where the filtration device is installed in a down flow reactor. As shown, the filtration device may be installed at the top of the reactor and positioned between the side walls of the reactor shell 110 and below a catch basin 100, e.g., if one is present. While FIG. 2 shows one embodiment of a possible installation of the device within a reactor, other configurations may be used. Also included in FIG. 2 for illustration purposes are a distribution tray (also referred to as a perforated tray) 70, a spacer ring 80 positioned between the distribution tray 70 and the base plate 10, and a seal ring 90 to provide a seal between the base plate and the reactor side wall. Distribution tray 70, spacer ring 80, and seal ring 90 are not required components of the filtration device or of the installation of the device within a reactor and are provided herein to illustrate a possible installation embodiment.

FIG. 3 shows the same central cross-sectional view as FIG. 2 in an embodiment where the filtration device is installed in a down flow reactor below a catch basin 100. Liquid 120 and gas 130 flow pathways are shown through the filtration media 15 and the flow bypass volume 25 within the filtration media volume 60, respectively. As shown, the flow of feedstream liquid is radially inward from the reactor side wall, passing through the filtration device inlet and the filtration media volume and then through the containment barrier and the base plate aperture located in the center of the filtration device.

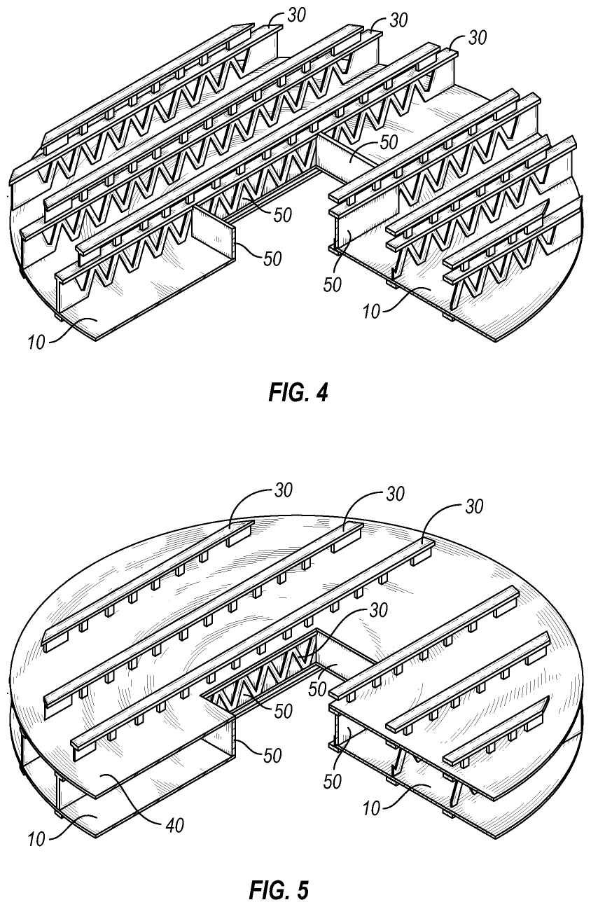

FIG. 4 shows a ¾ sectional isometric view of an embodiment of the filtration device with the top plate and the separator removed so that the internal arrangement of the cross member 30 supports and the containment barrier 50 may be easily seen. As shown, the base plate aperture located in the center of the base plate 10 provides manway access to the reactor internals below the filtration device. While cross members 30 are shown as truss supports, suitable alternative supporting members may be used.

FIG. 5 shows a ¾ sectional isometric view according to FIG. 4 with the separator 40 installed (also referred to as hold down screens) and supported at intermediate positions on the cross members 30. The separator generally has the same areal dimension as the base plate and contains a central opening that corresponds to the opening of the base plate aperture. Also shown are the top supports of the cross members 30 that support the top plate when installed.

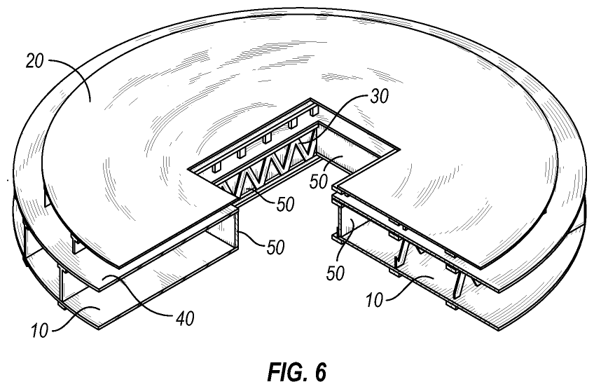

FIG. 6 shows a ¾ sectional isometric view according to FIG. 5 with the top plate 20 installed (also referred to as the deflector tray) and supported at the top of the cross members. Top plate 20 is shown with a central manway panel removed. The manway panel would be installed for normal reactor operation. Other components are also shown as in FIGS. 4 and 5 for reference.

The filtration device of the invention, including the specific embodiments described herein, provides certain benefits and improvements in hydroprocessing applications, including: the minimization of scale and small particles or fines from reaching the catalyst bed(s) and reactor internals below the filtration device; reduced pressure drop increase throughout the operation of the reactor, thereby allowing for full or extended run operation; the minimization of additional pressure drop through the reactor, even when the filter bed is completely fouled, i.e., full of contaminant; and, the potential reduction in the amount of grading material required in the top of the catalyst bed, thereby increasing the volume of active catalyst in the reactor.

The foregoing description of one or more embodiments of the invention is primarily for illustrative purposes, it being recognized that many variations might be used that would still incorporate the essence of the invention. Reference should be made to the following claims in determining the scope of the invention.

All patents and publications cited in the foregoing description of the invention are incorporated herein by reference.

1. A filtration device for removing contaminants from a liquid feedstream in a down-flow catalytic hydroprocessing reactor, the filtration device comprising:
a top plate having inner and outer surfaces and a top plate periphery;
a base plate generally parallel to the top plate having inner and outer surfaces, a base plate periphery, and a base plate aperture, wherein the top and base plates are separated by a distance to define an interior volume of the filtration device, and wherein the interior volume comprises a filtration media volume located on top of and adjacent to the base plate inner surface and a flow bypass volume located on top of the filtration media volume and adjacent to the top plate inner surface;
a base plate aperture containment barrier to retain filtration media on the base plate, located around the perimeter of the base plate aperture and extending from the base plate to the top of the filtration media volume or the bottom surface of the top plate;
a support structure for the top plate positioned within the interior volume of the filtration device comprising one or more supports to provide and maintain the separation distance between the top plate and the base plate;
a separator positioned between the filtration media volume and the flow bypass volume, wherein the separator is generally thin and parallel to both the top plate and the bottom plate, contains the filter media within the filtration media volume, and allows liquid to flow into the filtration media volume; and,
filtration media contained within the filtration media volume;
wherein, the base plate, the top plate, and the separator are centrally positioned about the same central perpendicular axis, the separator generally having the same areal dimension as the bottom plate, and the top plate having a smaller areal dimension than the bottom plate so that feedstream liquid and gas can flow into the filtration device inlet between the periphery of the top plate and the periphery of the base plate.

2. The filtration device of claim 1, wherein the device and each of the top plate, base plate, and separator are generally circular in dimension and are sized to fit horizontally within the top space of a down-flow catalytic hydroprocessing reactor.

3. The filtration device of claim 2, wherein the top plate has a smaller generally circular diameter than the base plate to define an annular filtration device inlet area around the top perimeter of the filtration device through which feedstream liquid and gas enters the device and flows inward toward the base plate aperture.

4. The filtration device of claim 1, wherein one or more of the top plate, the base plate, and the separator comprises a plurality of sections that together form the respective top plate, the base plate, or the separator, such that the sections may be placed within or removed from the reactor through a reactor internal access location.

5. The filtration device of claim 1, wherein the support structure comprises a plurality of cross members to support the top plate or sections of the top plate.

6. The filtration device of claim 5, wherein the cross members support the separator or sections of the separator.

7. The filtration device of claim 4, wherein the cross members support the base plate or sections of the base plate.

8. The filtration device of claim 4, wherein the cross members comprise a top support and an intermediate support between the top and the bottom of the cross member, wherein the top support supports the top plate or sections of the top plate and the intermediate support supports the separator or sections of the separator.

9. The filtration device of claim 1, wherein the separator comprises a wire, grid, mesh, screen, or perforated metal material that is sufficient to retain the filtration media within the filtration media volume.

10. The filtration device of claim 1, wherein the base plate aperture containment barrier comprises a wire, grid, mesh, screen, or perforated metal material that is sufficient to retain the filtration media within the filtration media volume and to allow feedstream liquid to flow from the filtration media volume into and through the base plate aperture.

11. The filtration device of claim 1, wherein the base plate aperture is centrally located in the base plate and of a sufficient dimension to allow manway access to portions of a reactor situated below the filtration device when installed in a down-flow catalytic hydroprocessing reactor.

12. The filtration device of claim 1, wherein the filtration media comprises a particulate filtration absorbent material having a nominal size in the range of about 5 to about 20 mm.

13. The filtration device of claim 1, wherein the device does not include a containment barrier located around the perimeter of the base plate extending from the base plate to the top of the filtration media volume or the bottom surface of the top plate, or wherein the filtration media is not contained around the perimeter of the base plate, or a combination thereof.

14. A down-flow catalytic hydroprocessing reactor comprising the filtration device of claim 1.

15. A process for removing contaminants from a liquid feedstream in a down-flow catalytic hydroprocessing reactor, the process comprising passing a feedstream to a down-flow catalytic hydroprocessing reactor through a filtration device installed at the top of the reactor according to claim 1, wherein the liquid and gas components of the feedstream pass through the inlet to the filtration device between the periphery of the top plate and the periphery of the base plate such that the feedstream liquid passes through the filtration media contained within the filtration media volume and the feedstream gas passes through the flow bypass volume of the filtration device interior volume.
